(19) United States
(12) Patent Application Publication
(10) Pub. No.: US 2026/0362106 A1
(43) Pub. Date: Nov. 12, 2026

(54) Methods and Apparatuses for Bluetooth Band Switching

(71) Applicant: Apple Inc., Cupertino, CA (US)

(72) Inventors: Chao LI, Nanjing (CN); Kai REN, Shanghai (CN); Sowmiya NARASIMHAN, Fremont, CA (US)

(21) Appl. No.: 19/655,805

(22) Filed: Apr. 23, 2026

(30) Foreign Application Priority Data
May 9, 2025 (CN) 202510603894.1

(51) Int. Cl. H04W 4/80; G06F 3/16; H04B 17/318; H04W 24/08

(52) U.S. Cl. CPC H04W 4/80; G06F 3/162; H04B 17/318; H04W 24/08

(57) ABSTRACT

An apparatus configured to generate, for transmission to at least one of a primary wireless audio output device and a secondary wireless audio output device over a first downlink on a first band, at least one audio packet, process a first acknowledgement over a first uplink on the first band from the primary wireless audio output device, determine a condition of the first downlink or the first uplink, generate, for transmission to the primary wireless audio output device, a request to enable advertising at a second band based on the condition, scan for an advertising packet received from the primary wireless audio output device on the second band to determine a condition of a link between the apparatus and the primary wireless audio output device on the second band and determine whether to switch to the second band or stay on the first band.

### BACKGROUND

A wireless communication device may provide audio data to one or more audio output devices using a short-range communication protocol. For example, a user may have the wireless communication device and a pair of wireless audio buds or wireless headphones. The wireless communication device may communicate with the wireless audio buds or headphones using a short-range communication protocol, such as Bluetooth. Once connected, the user may listen to music, a call, or any other type of audio with the wireless audio buds or headphones.

There have been efforts to utilize high frequency bands, such as the five GigaHertz (5GHz) band, for Bluetooth audio (BT5G). In this setting, BT5G may refer to the Unlicensed National Information Infrastructure (UNII)-1/3/5 band, or any band that is higher than the Industrial, Scientific, and Medical (ISM) band. Due to UNII-1/3/5 band essential free space, path loss is higher than that of the ISM band. Therefore, if the link quality is going to be bad at these UNII bands, then the BT5G device may need to switch its band from UNII to ISM.

The BT5G device may also be allowed to switch bands from the ISM band to the UNII band if the link quality/condition is good enough. However, due to UNII band path loss being higher than that of ISM, it is necessary to check the UNII band link quality before this kind of band switch. Unfortunately, the current Bluetooth audio protocol only supports checking the link quality at the current band. Thus, there is a need for a method and apparatus to check the band link quality (e.g., UNII band link quality) of the second (new) band before a band switch, such as a switch from ISM to UNII.

### SUMMARY

Some example embodiments are related to an apparatus having memory coupled to processing circuitry, the processing circuitry configured to generate, for transmission to at least one of a primary wireless audio output device and a secondary wireless audio output device over a first downlink on a first band, at least one audio packet, process a first acknowledgement over a first uplink on the first band from the primary wireless audio output device, determine a condition of the first downlink or the first uplink on the first band, generate, for transmission to the primary wireless audio output device, a request to enable advertising at a second band based on the condition, scan for an advertising packet received from the primary wireless audio output device on the second band to determine a condition of a link between the apparatus and the primary wireless audio output device on the second band and determine whether to switch to the second band or stay on the first band for additional transmission of audio packets based on the condition of the link on the second band.

Other example embodiments are related to an apparatus having memory coupled to processing circuitry, the processing circuitry configured to process at least one audio packet received over a downlink on a first band from an audio source, generate, for transmission to the audio source over an uplink on the first band, a first acknowledgement, process a request from the audio source to enable advertising on a second band, generate, for transmission on the second band, an advertising packet and process additional audio packets received from the audio source on the second band.

Still further example embodiments are related to an apparatus having memory coupled to processing circuitry, the processing circuitry configured to generate, for transmission to at least one of a primary wireless audio output device and a secondary wireless audio output device over a first downlink on a first band, at least one audio packet, process a first acknowledgement over a first uplink on the first band from the primary wireless audio output device, determine a condition of the first downlink or the first uplink on the first band, generate, for transmission to the primary wireless audio output device, a request to switch an UnTethered Protocol (UTP) link from the first band to a second band, receive a confirmation from the primary wireless audio output device that a UTP switch to the second band has occurred, snoop for a UTP acknowledgement at the second band from the secondary wireless audio output device to the primary wireless audio output device and determine whether to switch to the second band or stay on the first band for additional transmission of audio packets based on a result of the snoop of the UTP acknowledgement at the second band.

Additional example embodiments are related to an apparatus having memory coupled to processing circuitry, the processing circuitry configured to process at least one audio packet received over a downlink on a first band from an audio source, generate, for transmission to the audio source over an uplink on the first band, a first acknowledgement, process a request from the audio source to switch an UnTethered Protocol (UTP) link from the first band to a second band, generate, for transmission to the audio source over an uplink on the second band, a confirmation that a UTP switch to the second band has occurred and process additional audio packets received from the audio source on the second band.

### BRIEF DESCRIPTION OF THE DRAWINGS

FIG. 1 shows an example arrangement of a wireless communication device and wireless audio output device according to various example embodiments.

FIG. 2 shows an example wireless communication device according to various example embodiments.

FIG. 3 shows an example audio output device according to various example embodiments.

FIG. 4 shows a diagram illustrating an example arrangement of a wireless communication device and wireless audio output devices and links between the wireless communication device and wireless audio output devices according to various example embodiments.

FIG. 5 shows an example flow diagram for a method of switching between a first band and a second band for communications between a wireless communication device and a set of wireless audio output devices using advertising packets according to various example embodiments.

FIG. 6 illustrates an example audio time diagram for the example method of FIG. 5 according to various example embodiments.

FIG. 7 shows an example flow diagram 700 for a method of switching between a first band and a second band for communications between a wireless communication device and a set of wireless audio output devices using a UTP link according to various example embodiments.

FIG. 8 illustrates an example audio time diagram for the example method of FIG. 7 according to various example embodiments.

### DETAILED DESCRIPTION

The example embodiments may be further understood with reference to the following description and the related appended drawings, wherein like elements are provided with the same reference numerals. The example embodiments relate to implementing techniques for switching from a first band to a second band for communications between wireless audio output devices and a wireless communication device. In particular, the wireless communication device is enabled to check the actual conditions of the link between the wireless communication device and the wireless audio output devices at a second band before switching from the first band to the second band.

The example embodiments are described with regard to the wireless communication device providing audio data to one or more wireless audio output devices. Throughout this description, the terms “wireless communication device” and “source device” may be used interchangeably. However, any reference to a wireless communication device or a source device is merely provided for illustrative purposes. The example embodiments may be utilized with any electronic component equipped with hardware, software, and/or firmware configured to communicate with wireless audio output devices using a short-range communication protocol.

The wireless communication device may communicate with one or more wireless audio output devices. The term “wireless audio output device” generally refers to an electronic device that is configured to wirelessly receive audio data and generate audio output. Various examples described herein may reference examples of wireless audio output devices (e.g., audio buds, wireless headphones, wireless speakers, etc.), which are a specific type of wireless audio output device. Throughout this description, any reference to wireless audio output devices is merely provided for illustrative purposes. The example embodiments may be utilized with any electronic component equipped with hardware, software and/or firmware configured to communicate with a source device via a wireless communication protocol and generate audio output.

The example embodiments are also described with regard to a short-range communication protocol that enables short-range communication between two or more devices. Various examples described herein may reference Bluetooth (e.g., Bluetooth, Bluetooth Low-Energy (BLE), etc.), which is a specific type of short-range communication protocol. However, the example embodiments may be implemented using any type of wireless communication protocol or personal area network (PAN), e.g., WiFi Direct, ultrawideband (UWB) networks, etc. Throughout this description, any reference to the terms such as, “Bluetooth,” “short-range communication protocol,” “short-range connection,” or “short-range communication link” is merely provided for illustrative purposes. The example embodiments may apply to any appropriate type of communication protocol.

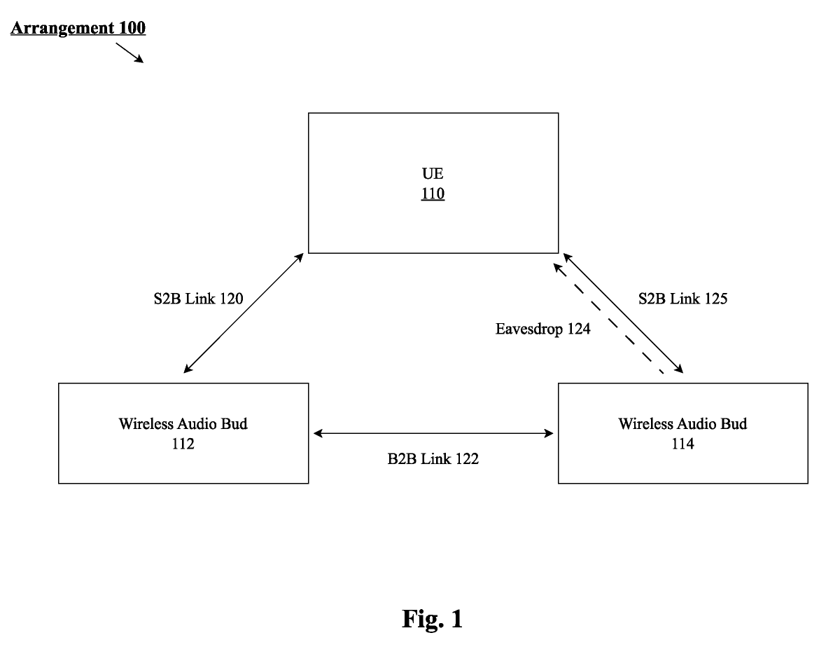

FIG. 1 shows an example arrangement 100 of a wireless communication device 110 and wireless audio output devices 112, 114 according to various example embodiments. The example arrangement 100 includes a wireless communication device 110. The wireless communication device 110 may represent any type of electronic component that is capable of communicating with one or more wireless audio output devices. Specific examples of the wireless communication device 110 include, but are not limited to, mobile phones, tablet computers, desktop computers, smartphones, embedded devices, wearables, Internet of Things (IoT) devices, video game consoles, media players, entertainment devices, smart speakers, smart TVs, streaming devices, etc. As mentioned above, the terms “wireless communication device” and “source device” may be used interchangeably throughout this description.

The wireless communication device 110 may communicate with a pair of wireless audio output devices 112, 114 (e.g., audio buds, audio buds, wireless headphones, etc.). However, any reference to wireless audio output device is merely provided for illustrative purposes. The example embodiments may apply to scenarios that include any appropriate type of audio output device, including one or more wireless speakers and devices with one or more integrated speakers.

The example arrangement 100 also illustrates various types of communication links and/or interactions that may occur when using the short-range communication protocol. In some embodiments, a network of these connections may represent a PAN.

The arrangement 100 shows a source-to-audio bud (S2B) link 120 between the wireless communication device 110 and the wireless audio bud 112 (primary bud). In addition, an audio bud-to-audio bud (B2B) link 122 is shown between the wireless audio bud 112 and the wireless audio bud 114 (secondary bud). In this example, the communication links 120, 122 may be Bluetooth connections or any other appropriate type of connection. Therefore, the wireless communication device 110 and the wireless audio output device 112, 114 may be equipped with an appropriate chipset to communicate using a short-range communication protocol.

In some example embodiments, the wireless audio bud 114 may be enabled to eavesdrop 124 (or snoop) on data being exchanged on the S2B link 120. In other example embodiments, the wireless audio bud 114 may establish a S2B link 125 with the wireless communication device 110. This additional S2B link 125 may be used instead of or in addition to the eavesdrop 124 and the B2B link 122.

Communication links (e.g., S2B 120, S2B 125, B2B 122) may be established using a manual approach, an automated approach, or a combination thereof. The manual approach refers to a process in which user input at one or more of the devices triggers the initiation of a connection establishment procedure. The automated approach refers to a mechanism in which connection establishment is initiated without a user-supplied command, e.g., using sensor data, proximity detection, an automated trigger, and/or other operations.

The arrangement 100 illustrates a possible network of short-range connections among the wireless communication device 110 and the wireless audio output device 112, 114. In some example embodiments, the wireless communication device 110 and the audio bud 112 have a primary/secondary relationship over the S2B link 120 where the wireless communication device 110 is in control and/or has priority over the audio bud 112. Similarly, the wireless communication device 110 and the audio bud 114 may also have a primary/secondary relationship over the S2B link 125 where the wireless communication device 110 is in control and/or has priority over the audio bud 114.

In addition, the audio bud 112 and the audio bud 114 may have a primary/secondary relationship over the B2B link 122 where the audio bud 112 is in control and/or has priority over the audio bud 114. In other example embodiments, devices connected via a short-range communication protocol (e.g., S2B link 120, S2B link 125, B2B link 122) may have a mutual relationship where the devices share or negotiate certain responsibilities.

A primary/secondary relationship between audio buds may be dynamic. For example, at a first time, the audio bud 112 may be set as the primary bud and the audio bud 114 may be set as the secondary bud. Subsequently, a predetermined condition may trigger the audio bud 114 to be set as the primary bud. Thus, at a second time, the audio bud 114 may be set as the primary bud and the audio bud 112 may be set as the secondary bud. During a session (e.g., streaming, a call, etc.), the pair of audio bud 112, 114 may switch roles any number of times. However, for purposes of the following description, the wireless audio bud 112 will be referred to as the primary bud and the wireless audio bud 114 will be referred to as the secondary bud.

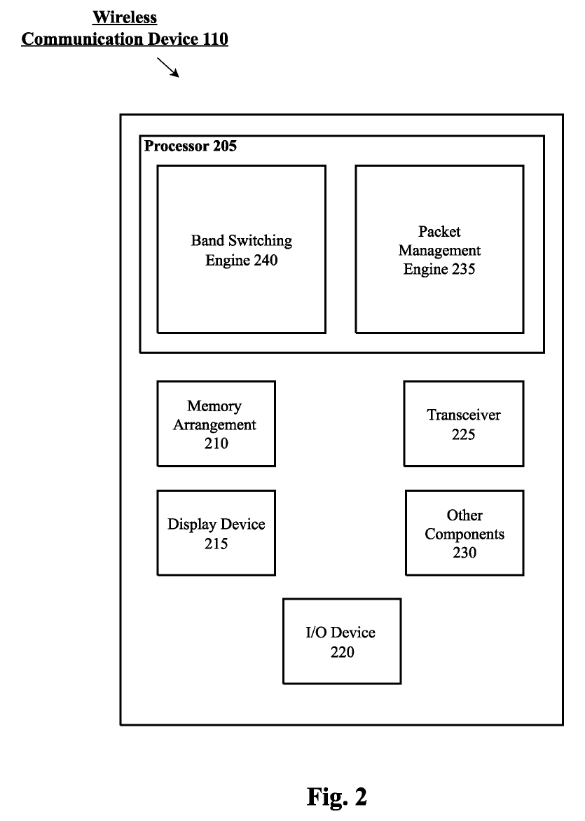

FIG. 2 shows an example wireless communication device 110 according to various example embodiments. The wireless communication device 110 will be described with regard to the arrangement 100 of FIG. 1. The wireless communication device 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the wireless communication device 110 to other electronic devices, etc.

The processor 205 may be configured to execute a plurality of engines of the wireless communication device 110. For example, the engines may include a packet management engine 235. The packet management engine 235 may be configured to perform operations related to processing microphone audio packets from both wireless audio output devices 112,114 and voice accelerometer data.

The engines may also include a Band Switching Engine 240. The Band Switching Engine 240 may be configured to perform operations to switch between a first band and a second band for communications between the wireless communication device 110 and wireless audio output devices. In particular, the Band Switching Engine 240 may check the actual conditions of a link between the wireless communication device 110 and wireless audio output devices at a second band to see if the conditions are good enough for a band switch from a first band to a second band. The Band Switching Engine 240 may transmit a request to the wireless audio output device to enable advertising, with this advertising being at a second band, such as the UNII band. The Band Switching Engine 240 may advertisement scan the advertising packet from a primary wireless audio output device to check the condition of the link at the second (UNII) band based on the advertising packet and to determine whether to switch from the first (ISM) band to the second (UNII) band. Alternatively, the Band Switching Engine can send a request to a primary wireless audio output device to switch its UnTethered Protocol (UTP) link to a second (UNII) band.

The above referenced engines 235 and 240 being applications (e.g., programs) executed by the processor 205 are merely provided for illustrative purposes. The functionality associated with the engines 235 and 240 may also be represented as a separate incorporated component of the wireless communication device 110 or may be a modular component coupled to the wireless communication device 110, e.g., an integrated circuit with or without firmware. For example, the integrated circuit may include input circuitry to receive signals and processing circuitry to process the signals and other information. The engines may also be embodied as one application or separate applications. In addition, in some wireless communication devices, the functionality described for the processor 205 is split among two or more processors such as a baseband processor and an applications processor. The example embodiments may be implemented in any of these or other configurations of a wireless communication device.

The memory arrangement 210 may be a hardware component configured to store data related to operations performed by the wireless communication device 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may represent one or more hardware components configured to perform operations related to wireless communication. For example, the transceiver 225 may represent one or more radios configured to communicate with a cellular network, a PAN, a wireless local area network (WLAN), etc. As indicated above, the example embodiments may include the wireless communication device 110 communicating with a first audio output device over a first frequency band and a second audio output device over a second different frequency band. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein.

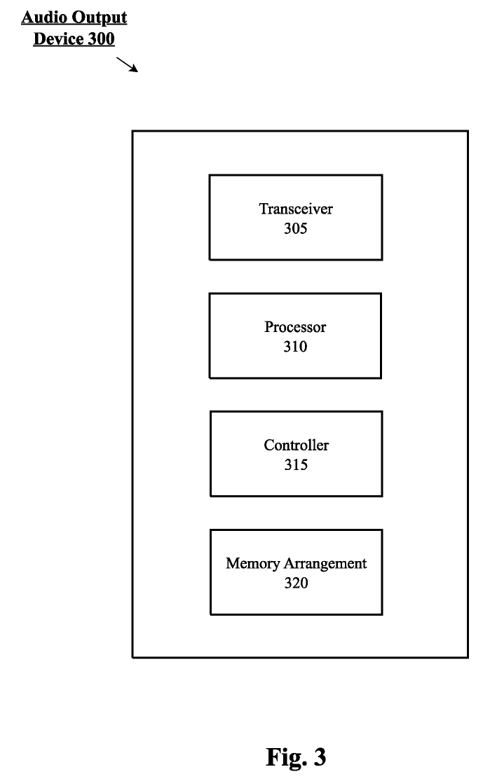

FIG. 3 shows an example audio output device 300 according to various example embodiments. The audio output device 300 may represent either or both of the audio buds 112, 114 shown in the arrangement 100.

The device 300 may include a transceiver 305, a processor 310 and a controller 315. In addition, the device 300 may include other components (not shown) such as, but not limited to, a microphone, a memory, a battery and ports to electrically connect the device 300 to other electronic devices.

The transceiver 305 may represent one or more hardware components configured to perform operations related to wireless communication. For example, the transceiver 305 may represent one or more radios configured to communicate with a PAN or any other appropriate type of network. The transceiver 305 may enable a short-range connection to be established using frequencies or channels associated with the short-range connection (e.g., Bluetooth). The transceiver 305 includes circuitry configured to transmit and/or receive signals (e.g., control signals, data signals). Such signals may be encoded with information implementing any one of the methods described herein. In some embodiments, these frequencies may include the 2.4 GHz and 5 GHz bands. Accordingly, the transceiver 305 may operate on a variety of different frequencies or channels (e.g., set of consecutive frequencies).

The processor 310 may be configured to execute a plurality of engines for the audio output device 300. For example, the processor 310 may perform operations related to receiving connection information from a source device and joining an existing audio session. In some embodiments, the processor 310 may be represented as a separate incorporated component of the audio output device 300 or may be a modular component coupled to the audio output device 300, e.g., an integrated circuit with or without firmware. For example, the processor 310 may be a chip or integrated circuit compatible with the short-range communication protocol that includes input circuitry to receive signals and processing circuitry to process the signals and other information. The engines may also be embodied as one application or separate applications. In some embodiments, the functionality described for the processor 310 is split among two or more processors such as a baseband processor and an applications processor. In other embodiments, the transceiver 305 may also be configured to execute engines and/or operations for the audio output device 300.

The controller 315 may be configured to control the communication functions of the transceiver 305 and/or the processor 310. In addition, the controller 315 may also control non-communication functions related to the other components such as the memory, the battery, etc. Accordingly, the controller 315 may perform operations associated with an applications processor. The example embodiments may be implemented in any of these or other configurations of an audio output device.

The audio output device 300 may also have a memory arrangement 320. The memory arrangement 320 may be a hardware component configured to store data related to operations performed by the audio output device 300. For example, the memory arrangement 320 may store sensor data associated with the audio output device 300.

Recently there have been efforts to utilize high frequency bands, such as the five GigaHertz (5GHz) band, for Bluetooth audio (BT5G). In this setting, BT5G may refer to the Unlicensed National Information Infrastructure (UNII)-1/3/5 band, or any band that is higher than the Industrial, Scientific, and Medical (ISM) band. Due to UNII-1/3/5 band essential free space, pathloss is higher than that of the Industrial, Scientific, and Medical (ISM) band. Therefore, if the link quality is going to be bad at these UNII bands (i.e., Retransmissions (ReTx), Non-Acknowledgement (NAK) or Transmission Flush (TxFlush) is higher than a certain level, then the BT5G device will switch its band from UNII to ISM.

The BT5G device is also allowed to switch bands from ISM to UNII band if the link quality/condition is good enough. However, due to UNII band pathloss being higher than ISM, the UNII band link quality may be checked before this kind of band switch, and in some embodiments, to check a Received Signal Strength Indicator (RSSI) level between an audio source, such as a smart phone, and an audio sink, such as wireless audio buds or wireless headphones. Unfortunately, the current Bluetooth audio protocol only supports checking the peers’ RSSI at the current band. Thus, there is a need for a method and apparatus to check the band link quality of a second band (e.g., the UNII band link quality) before a band switch, such as a switch from ISM to UNII.

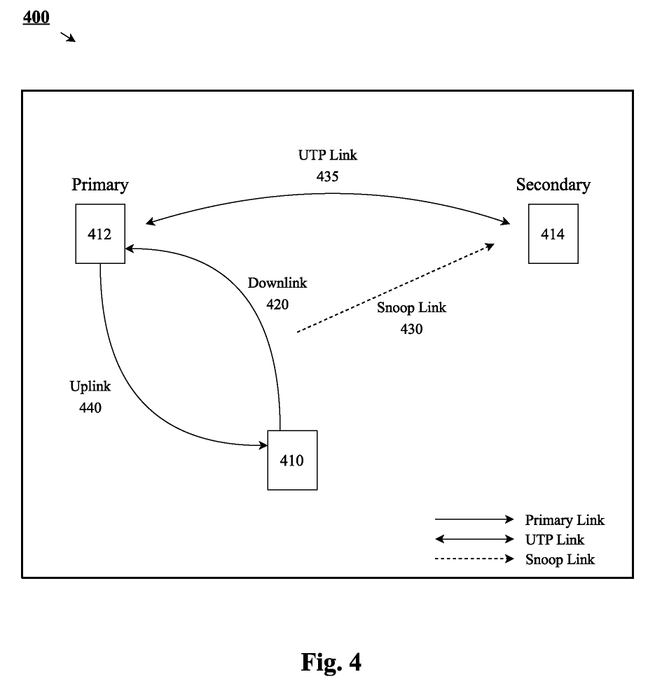

FIG. 4 shows a diagram illustrating an example arrangement of a wireless communication device and wireless audio output devices and links between the wireless communication device and wireless audio output devices according to various example embodiments. In the arrangement 400 of FIG. 4, there is a wireless communication device (such as a smart phone) 410 and a pair of wireless audio output devices (such as audio buds) 412 and 414. In some example embodiments, the smart phone 410 is an audio source device and the pair of wireless audio output devices include a primary audio bud 412 and a secondary audio bud 414. In one embodiment, the smart phone 410 may send an audio packet to the primary audio bud 412 via a Primary Link Downlink 420. The secondary audio bud 414 may snoop the audio packet from the smart phone 410 to the primary audio bud 412 via a snoop link 430. The secondary audio bud 414 may transmit an acknowledgment or non-acknowledgment (ACK/NAK) to the primary audio bud 412 via an untethered protocol (UTP) link 435. This is always at an ISM band. The primary audio bud 414 may send an ACK/NAK to the smart phone 410 based on itself and the secondary ACK/NAK status via a Primary Link Uplink 440. In the scenario where the Primary Links 420 and 440 and the snoop link 430 are all at an ISM band, and if the Primary Link Downlink 420 or the Primary Link Uplink 440 wants to switch to an UNII band, currently the only way to estimate the UNII band link condition before switching is to leverage the current ISM band primary link RSSI between the smart phone 410 and the primary audio bud 412. However, this approach can only provide a prediction of the UNII band link condition, not the real UNII link condition.

To check the band link quality (e.g., UNII band link quality) before a band switch, such as a switch from ISM to UNII, a new method is proposed. The new method includes checking the actual conditions of a link between the audio source and wireless audio output devices at a second band to see if the conditions are good enough for a band switch from a first band to the second band. The method may include transmitting a request to the wireless audio output device to enable advertising, with this advertising being at a second band, such as the UNII band. The method may also include scanning the advertising packet from a primary wireless audio output device to check the condition of the link at the second (UNII) band based on the advertising packet and to determine whether to switch from the first (ISM) band to the second (UNII) band.

Alternatively, instead of using advertising packets, the audio source may transmit a request to a primary wireless audio output device to switch its UnTethered Protocol (UTP) link to a second (UNII) band. The specific UNII band to be switched to may vary and may be included in the UTP switch request. If the primary wireless audio device confirms that the UTP switch is done, then the audio source may snoop the UTP Ack from the secondary wireless audio device to the primary wireless audio device and check the condition of the link at the UNII band. In some example embodiments, the condition of the link may be based on the RSSI result at the UNII band. Based on the condition of the link at the UNII band, the audio source may determine whether to switch from the first (ISM) band to the second (UNII) band.

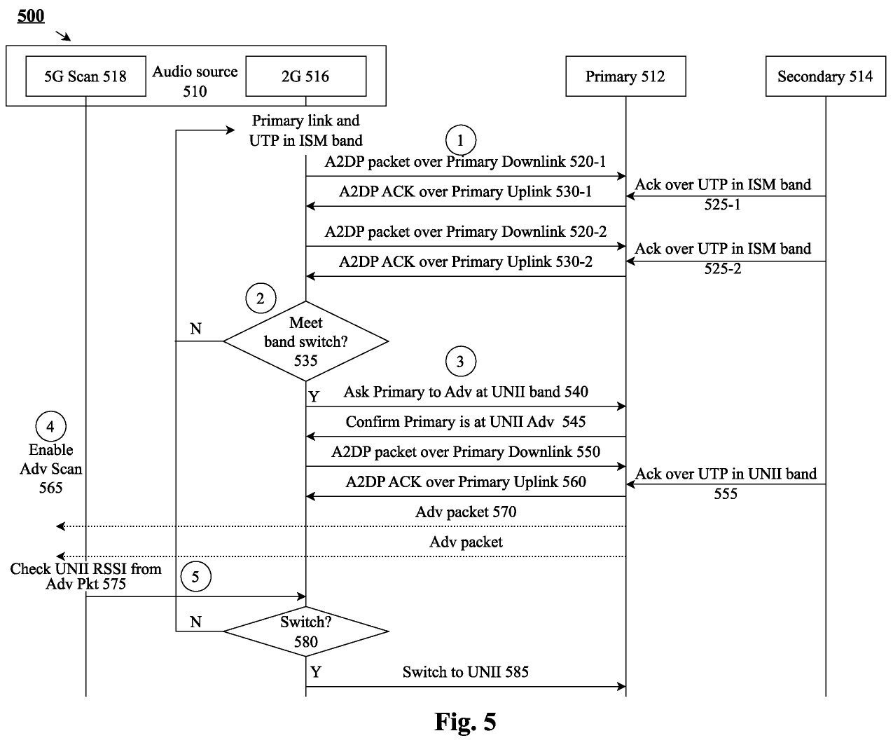

FIG. 5 shows an example flow diagram 500 for a method of switching between a first band and a second band for communications between a wireless communication device and a set of wireless audio output devices according to various example embodiments. In FIG. 5, there is an audio source 510 and a pair of wireless audio output devices 512 and 514. In one embodiment, the audio source 510 may be a smart phone and the pair of wireless audio output devices 512 and 514 may be a primary audio bud and a secondary audio bud as discussed above. Although FIG. 5 shows one audio source and a pair of wireless audio output devices, this is an example only and any number of appropriate audio sources and wireless audio output devices may be used.

In one embodiment, the audio source 510 has a BT 2G core 516 for the primary link with the primary audio bud 512, and the primary audio bud 512 may use UTP (UnTethered Protocol) to communicate with the secondary audio bud(s) 514. In one embodiment, the primary link and the UTP link may be in the ISM band. The audio source 510 may also include a 5G scan core 518. In the example flow diagram 500 of FIG. 5, an audio packet, such as an Advanced Audio Distribution Profile (A2DP) packet, may be transmitted over the Primary Downlink at the ISM band from the audio source 510 to the primary audio bud 512 (520-1). The A2DP packet may comprise an encoded audio data frame. The secondary audio bud 514 may send an ACK packet over a UTP link at an ISM band to the primary audio bud 512 to acknowledge its snoop status (525-1). The primary audio bud 514 may transmit an A2DP ACK packet over a Primary Uplink at an ISM band, where the A2DP ACK packet may take ACK or NAK status based on the primary audio bud and the secondary audio bud’s receive feedback (530-1). These steps may be repeated for additional A2DP packets (520-2 through 530-2).

At some point, the audio source 510 may check conditions to determine if the conditions are satisfactory for a band switch from a first band to a second band (535). For example, if key performance indicators (KPI) at the ISM band do not satisfy predetermined thresholds, then the link conditions between the audio source 510 and the audio buds 512 and 514 are good enough in the ISM band. In this situation, a band switch is not triggered. The KPI may include parameters such as Retransmissions (ReTx), Non-Acknowledgement (NAK) or Transmission Flush (TxFlush). On the other hand, if the link quality is unsatisfactory (e.g., the ReTx rate, the NAK rate, and/or the TxFlush count is higher than a predetermined thresholds), then the audio source may switch its band.

At 540, if the conditions are met for a band switch, the audio source 510 may attempt a band switch by transmitting a request to the primary audio bud 512 to enable advertising, with this advertising being at the UNII band. This request can be a link manager protocol packet in one example embodiment. As long as the primary audio bud 512 receives this request, it will determine whether advertising at the UNII band is warranted and may also inform the audio source 510 of the confirmation (545). An Advanced Audio Distribution Profile (A2DP) packet may be transmitted over the Primary Downlink from the audio source 510 to the primary audio bud 512 (550). The A2DP packet may comprise an encoded audio data frame. The secondary audio bud 514 may send an ACK packet over a UTP link at an ISM band to the primary audio bud 512 to acknowledge its snoop status (555). The primary audio bud 514 may transmit an A2DP ACK packet over a Primary Uplink at an ISM band, where the A2DP ACK packet may take ACK or NAK status based on receive feedback from the primary audio bud and the secondary audio bud (560).

If the primary audio bud 512 confirms that advertising is enabled at the UNII band, then the audio source 510 enables its 5G scan core 518 (565). The primary audio bud 512 may send advertising packets to the 5G scan core 518 (570). The audio source 510 may keep sending A2DP packets to the primary audio bud 512; meanwhile, the primary audio bud 512 may continue to send advertising packets at the UNII band to the 5G scan core 518 of the audio source 510.

At 575, the audio source 510 may use its 5G scan core 518 to advertisement scan the advertising packet from the primary audio bud 512 and check the condition of the link at the UNII band based on the advertising packet. In some example embodiments, the condition of the link may be based on the RSSI result at the UNII band based on the advertising packet. Based on the condition of the link at the UNII band, the audio source 510 may determine whether to switch from the ISM band to the UNII band (580). In some example embodiments, if the condition of the link satisfies a predetermined threshold, the audio source 510 switches to the UNII band (585). If the predetermined threshold is not satisfied, the audio source 510 may stay at the current ISM band. In some example embodiments, the decision to switch may be based on the KPI mentioned above and/or the RSSI at the UNII band. For example, the audio source may switch to the second band for additional transmission of audio packets if the RSSI result at the second band is higher than a first predetermined threshold, or if a ReTx rate, a NAK rate, and/or the TxFlush count is higher than a second predetermined threshold. On the other hand, the audio source may decide to remain on the first band for additional transmission of audio packets if the RSSI result at the second band is lower than the first predetermined threshold, or if the ReTx rate, a NAK rate, and/or the TxFlush count is lower than the second predetermined threshold.

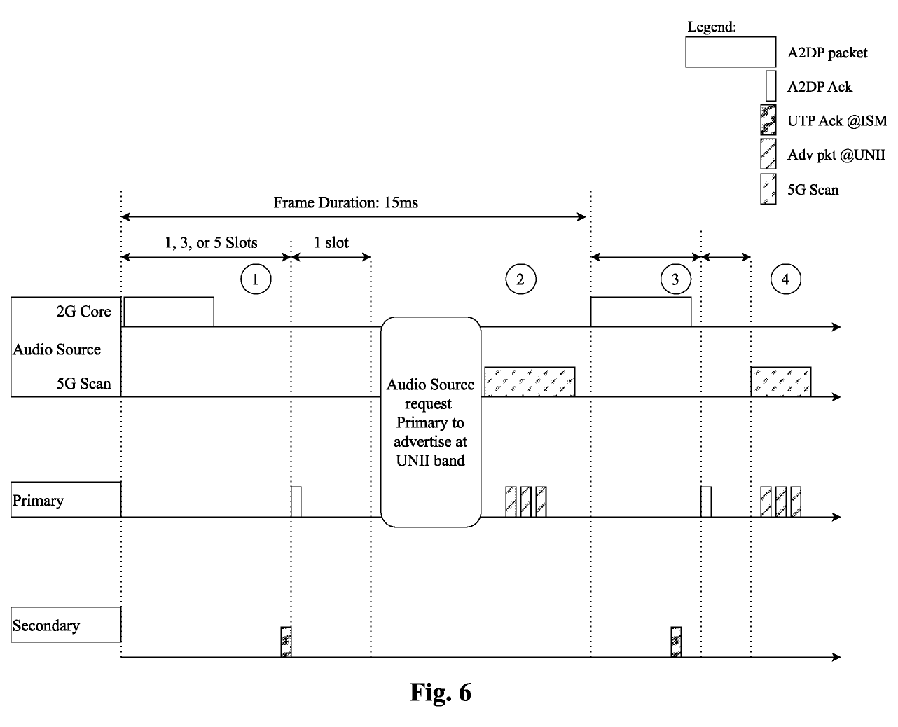

FIG. 6 illustrates an example audio time diagram for the example method of FIG. 5 according to various example embodiments. The audio time diagram 600 of FIG. 6 is broken into four parts. In Part 1, the audio source (e.g., smart phone) and the primary and secondary audio buds are in BT5G mode and the smart phone sends an audio packet to the primary audio bud via its 2G core. The secondary audio bud snoops and sends a UTP Ack to the primary audio bud at the ISM band. The primary audio bud sends an ACK/NAK to the smart phone.

In Part 2 of FIG. 6, the smart phone requests that the primary audio bud and the secondary audio bud switch to the UNII band by requesting advertising at the UNII band. In Part 3, the steps of Part 1 are followed for Bluetooth audio transmission, but the secondary audio bud sends the ACK to the primary audio bud at the UNII band. Meanwhile, the smart phone enables its 5G scan core to capture UTP at the UNII band (Part 4).

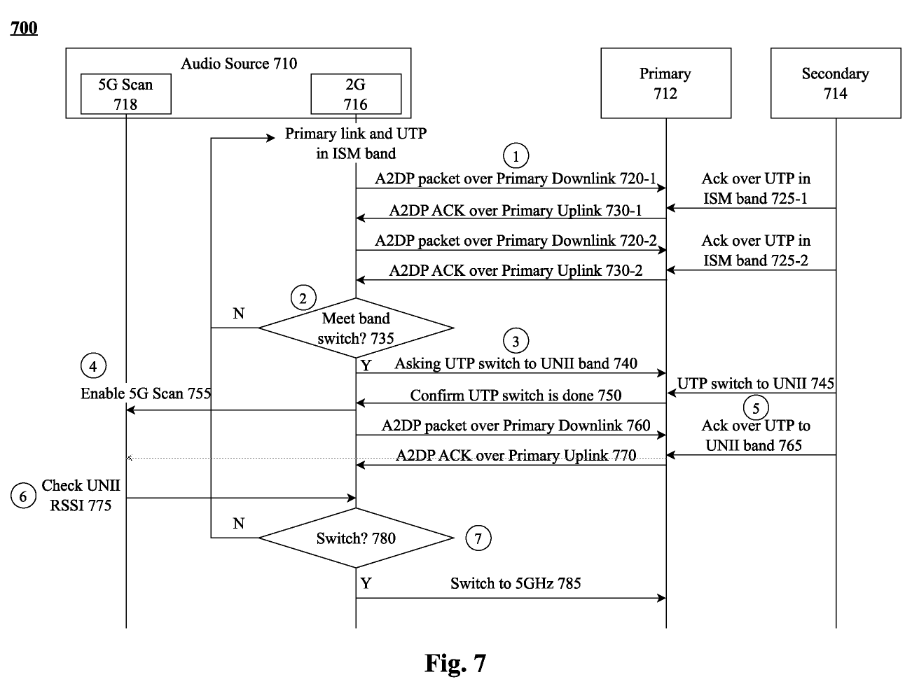

In an alternate embodiment, it may be possible for the BT5G device to switch bands using the UTP (UnTethered Protocol) link. FIG. 7 shows an example flow diagram 700 for a method of switching between a first band and a second band for communications between a wireless communication device and a set of wireless audio output devices using a UTP link according to various example embodiments. In FIG. 7, there is an audio source 710 and a pair of wireless audio output devices 712 and 714. In one embodiment, the audio source 710 may be a smart phone and the pair of wireless audio output devices 712 and 714 may be a primary audio bud and a secondary audio bud as discussed above. Although FIG. 7 shows one audio source and a pair of wireless audio output devices, this is an example only and any number of appropriate audio sources and wireless audio output devices may be used.

In one embodiment, the audio source 710 has a BT 2G core 716 for the primary link with the primary audio bud 712, and the primary audio bud 712 may use UTP (UnTethered Protocol) to communicate with the secondary audio bud(s) 714. In one embodiment, the primary link and the UTP link may be in the ISM band. The audio source 710 may also include a 5G scan core 718.

In the example flow diagram 700 of FIG. 7, an audio packet, such as an Advanced Audio Distribution Profile (A2DP) packet, may be transmitted over the Primary Downlink at the ISM band from the audio source 710 to the primary audio bud 712 (720-1). The A2DP packet may comprise an encoded audio data frame. The secondary audio bud 714 may send an ACK packet over a UTP link at an ISM band to the primary audio bud 712 to acknowledge its snoop status (725-1). The primary audio bud 714 may transmit an A2DP ACK packet over a Primary Uplink at an ISM band, where the A2DP ACK packet may take ACK or NAK status based on the primary audio bud and the secondary audio bud’s receive feedback (730-1). These steps may be repeated for additional A2DP packets (720-2 through 730-2).

At some point, the audio source 710 may check conditions to determine if the conditions are satisfactory for a band switch from a first band to a second band (735). For example, if key performance indicators (KPI) at the ISM band do not satisfy predetermined thresholds, then the link conditions between the audio source 710 and the audio buds 712 and 714 are good enough in the ISM band. In this situation, a band switch is not triggered. The KPI may include parameters such as Retransmissions (ReTx), Non-Acknowledgement (NAK) or Transmission Flush (TxFlush). On the other hand, if the link quality is unsatisfactory (e.g., the ReTx rate, the NAK rate, and/or the TxFlush count is higher than a predetermined thresholds), then the audio source may switch its band.

At 740, if the conditions are met for a band switch, the audio source 710 may attempt a band switch by transmitting a request to the primary audio bud 712 for the primary audio bud and/or the secondary audio bud 714 to switch its UTP link to a different (UNII) band. In one embodiment, the primary audio bud 712 may forward this request to the secondary audio bud 714 or the secondary audio bud 714 may snoop or eavesdrop to receive the UTP switch request. The specific UNII band for the switch may vary and may be included in the UTP switch request. This request can be a link manager protocol packet in one example embodiment. As long as the primary audio bud 712 receives this request, it will coordinate with the secondary audio bud 714 to determine using the requested UNII band or not at the UTP link, and the primary audio bud may also inform the audio source 710 of the confirmation of the request to switch. In particular, the secondary audio bud 714 will confirm its snoop status and transmit to the primary audio bud 712 an acknowledgment of the UTP switch to UNII (745). The primary audio bud 712 will confirm to the audio source 710 that the UTP switch is done (750).

If the primary audio bud 712 confirms that the UTP switch is done, then the audio source 710 enables its 5G scan core 718 (755). The audio source 710 may send (or continue to send) one or more A2DP packets to the primary audio bud 712 over a primary downlink (760). The A2DP packet(s) may comprise an encoded audio data frame. The secondary audio bud 714 may send an ACK packet over a UTP link at the UNII band to the primary audio bud 712 to acknowledge its snoop status (765). The primary audio bud 714 may transmit an A2DP ACK packet over a Primary Uplink to the audio source 710, where the A2DP ACK packet may take ACK or NAK status based on receive feedback from the primary audio bud and the secondary audio bud (770).

At 775, the audio source 710 may use its 5G scan core 718 to snoop the UTP Ack from the secondary audio bud 714 to the primary audio bud 712 and check the condition of the link at the UNII band. In some example embodiments, the condition of the link may be based on the RSSI result at the UNII band. Based on the condition of the link at the UNII band, the audio source 710 may determine whether to switch from the ISM band to the UNII band (780). In some example embodiments, if the condition of the link satisfies a predetermined threshold, the audio source 710 switches to the UNII band (785). If the predetermined threshold is not satisfied, the audio source 710 may stay at the current ISM band. In some example embodiments, the decision to switch may be based on the KPI mentioned above and/or the RSSI at the UNII band. For example, the audio source 710 may switch to the second band for additional transmission of audio packets if the RSSI result at the second band is higher than a first predetermined threshold, or if a ReTx rate, a NAK rate, and/or the TxFlush count is higher than a second predetermined threshold. On the other hand, the audio source 710 may decide to remain on the first band for additional transmission of audio packets if the RSSI result at the second band is lower than the first predetermined threshold, or if the ReTx rate, a NAK rate, and/or the TX Flush count is lower than the second predetermined threshold.

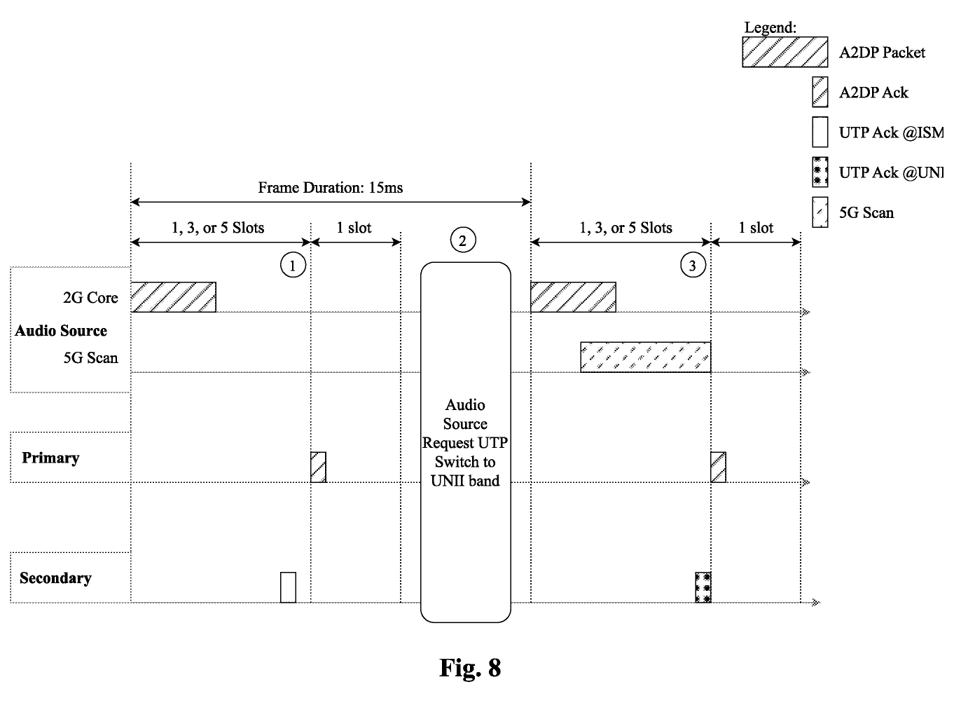

FIG. 8 illustrates an example audio time diagram for the example method of FIG. 7 according to various example embodiments. The audio time diagram 800 of FIG. 8 is broken into four parts. In Part 1, the audio source (e.g., smart phone) and the primary and secondary audio buds are in BT5G mode and the smart phone sends an audio packet to the primary audio bud via its 2G core. The secondary audio bud snoops and sends a UTP Ack to the primary audio bud at the ISM band. The primary audio bud sends an ACK/NAK to the smart phone.

In Part 2 of FIG. 8, the smart phone requests that the primary audio bud and the secondary audio bud switch the UTP link to a different (UNII) band. The specific UNII band to be switched to may vary and may be included in the UTP switch request. In Part 3, the steps of Part 1 are followed for Bluetooth audio transmission, but the secondary audio bud sends the ACK to the primary audio bud at the UNII band. Meanwhile, the smart phone enables its 5G scan core to capture UTP at the UNII band (Part 4).

### Examples

In a first example, a method, comprising generating, for transmission to at least one of a primary wireless audio output device and a secondary wireless audio output device over a first downlink on a first band, at least one audio packet, processing a first acknowledgement over a first uplink on the first band from the primary wireless audio output device, determining a condition of the first downlink or the first uplink on the first band, generating, for transmission to the primary wireless audio output device, a request to enable advertising at a second band based on the condition, scanning for an advertising packet received from the primary wireless audio output device on the second band to determine a condition of a link between the apparatus and the primary wireless audio output device on the second band and determining whether to switch to the second band or stay on the first band for additional transmission of audio packets based on the condition of the link on the second band.

In a second example, the method of the first example, wherein the first band is an International, Scientific, and Medical (ISM) band and the second band is an Unlicensed National Information Infrastructure (UNII) band.

In a second example, the method of the first example, wherein the first band is an Unlicensed National Information Infrastructure (UNII) band and the second band is an International, Scientific, and Medical (ISM) band.

In a second example, the method of the first example, wherein the audio packet is an Advanced Audio Distribution Profile (A2DP) packet.

In a fifth example, the method of the fourth example, wherein the A2DP packet comprises an encoded audio frame.

In a sixth example, the method of the first example, wherein the first acknowledgement is based at least in part on a second acknowledgement received by the primary wireless audio output device from the secondary wireless audio output device.

In a seventh example, the method of the sixth example, wherein the second acknowledgement is received by the primary wireless audio output device from the secondary wireless audio output device over an UnTethered Protocol (UTP) link on the first band.

In an eighth example, the method of the first example, wherein determining the condition of the first downlink or the first uplink on the first band is based on key performance indicators (KPI) on the first band, the KPI including one or more of Retransmissions (ReTx), Non-Acknowledgements (NAK) or Transmission Flushes (TxFlush).

In a ninth example, the method of the eighth example, wherein, when a ReTx rate, a NAK rate, or a TxFlush count is lower than a predetermined threshold, the condition of the first downlink or the first uplink on the first band is satisfactory.

In a tenth example, the method of the eighth example, wherein, wherein, when a ReTx rate, a NAK rate, or a TxFlush count is higher than a predetermined threshold, the condition is unsatisfactory and a switch to the second band is to be attempted.

In an eleventh second example, the method of the first example, wherein the request to enable advertising comprises a link manager protocol packet.

In a twelfth example, the method of the first example, wherein the processing circuitry is configured to determine the condition of a link between the apparatus and the primary wireless audio output device on the second band based on one or more of a Received Signal Strength Indicator (RSSI) result at the second band based on a result of the scan of the advertising packet.

In a thirteenth example, the method of the twelfth example, wherein determining whether to switch to the second band or stay on the first band for additional transmission of audio packets is based on the RSSI result at the second band and key performance indicators (KPI) on the first band, the KPI including one or more of Retransmissions (ReTx), Non-Acknowledgements (NAK) or Transmission Flushes (TxFlush).

In a fourteenth example, the method of the thirteenth example, wherein switching to the second band for additional transmission of audio packets is performed when the RSSI result at the second band is higher than a first predetermined threshold or a ReTx rate, a NAK rate, or a TxFlush count is higher than a second predetermined threshold.

In a fifteenth example, the method of the thirteenth example, wherein remaining on the first band for additional transmission of audio packets is performed when the RSSI result at the second band is lower than a first predetermined threshold or a ReTx rate, a NAK rate, or a TxFlush count is lower than a second predetermined threshold.

In a sixteenth example, the method of the first example, further comprising switching to the second band and generating, for transmission to the primary wireless audio output device over a second downlink on a second band, at least one audio packet.

In a seventeenth example, a processor configured to perform any of the methods of the first through sixteenth examples.

In an eighteenth example, a method, comprising processing at least one audio packet received over a downlink on a first band from an audio source, generating, for transmission to the audio source over an uplink on the first band, a first acknowledgement, processing a request from the audio source to enable advertising on a second band, generating, for transmission on the second band, an advertising packet and processing additional audio packets received from the audio source on the second band.

In a nineteenth example, the method of the eighteenth example, wherein the first band is an International, Scientific, and Medical (ISM) band and the second band is an Unlicensed National Information Infrastructure (UNII) band.

In a twentieth example, the method of the eighteenth example, wherein the first band is an Unlicensed National Information Infrastructure (UNII) band and the second band is an International, Scientific, and Medical (ISM) band.

In a twenty first example, the method of the eighteenth example, further comprising determining, based on the request from the audio source to enable advertising on the second band, whether advertising is to be enabled on the second band before the transmission of an advertising packet to the audio source on the second band.

In a twenty second example, the method of the eighteenth example, wherein the first acknowledgement is based at least in part on a second acknowledgement received from a secondary wireless audio output device.

In a twenty third example, the method of the twenty second example, wherein the second acknowledgement is received from the secondary wireless audio output device over an UnTethered Protocol (UTP) link on the first band.

In a twenty fourth example, the method of the twenty second example, wherein after receiving the additional audio packets from the audio source on the second band, the processing circuitry is configured to cause transmitting circuitry to transmit a third acknowledgement over an uplink to the audio source on the second band, the third acknowledgement based at least in part on a fourth acknowledgement received from the secondary wireless audio output device over an UnTethered Protocol (UTP) link on the second band.

In a twenty fifth example, a processor configured to perform any of the methods of the eighteenth through twenty fourth examples.

In a twenty sixth example, a method, comprising generating, for transmission to at least one of a primary wireless audio output device and a secondary wireless audio output device over a first downlink on a first band, at least one audio packet, processing a first acknowledgement over a first uplink on the first band from the primary wireless audio output device, determining a condition of the first downlink or the first uplink on the first band, generating, for transmission to the primary wireless audio output device, a request to switch an UnTethered Protocol (UTP) link from the first band to a second band, receiving a confirmation from the primary wireless audio output device that a UTP switch to the second band has occurred, snooping for a UTP acknowledgement at the second band from the secondary wireless audio output device to the primary wireless audio output device and determining whether to switch to the second band or stay on the first band for additional transmission of audio packets based on a result of the snoop of the UTP acknowledgement at the second band.

In a twenty seventh example, the method of the twenty sixth example, wherein the first band is an International, Scientific, and Medical (ISM) band and the second band is an Unlicensed National Information Infrastructure (UNII) band.

In a twenty eighth example, the method of the twenty sixth example, wherein the first band is an Unlicensed National Information Infrastructure (UNII) band and the second band is an International, Scientific, and Medical (ISM) band.

In a twenty ninth example, the method of the twenty sixth example, wherein the audio packet is an Advanced Audio Distribution Profile (A2DP) packet.

In a thirtieth example, the method of the twenty ninth example, wherein the A2DP packet comprises an encoded audio frame.

In a thirty first example, the method of the twenty sixth example, wherein the first acknowledgement is based at least in part on a second acknowledgement received by the primary wireless audio output device from the secondary wireless audio output device.

In a thirty second example, the method of the thirty first example, wherein the second acknowledgement is received by the primary wireless audio output device from the secondary wireless audio output device over an UnTethered Protocol (UTP) link on the first band.

In a thirty third example, the method of the twenty sixth example, wherein determining the condition of the first downlink or the first uplink on the first band is based on key performance indicators (KPI) on the first band, the KPI including one or more of Retransmissions (ReTx), Non-Acknowledgements (NAK) or Transmission Flushes (TxFlush).

In a thirty fourth example, the method of the thirty third example, wherein, when a ReTx rate, a NAK rate, or a TxFlush count is lower than a predetermined threshold, the condition of the first downlink or the first uplink on the first band is satisfactory.

In a thirty fifth example, the method of the thirty third example, wherein, when a ReTx rate, a NAK rate, or a TxFlush count is higher than a predetermined threshold, the condition is unsatisfactory and the UTP switch to the second band is to be attempted.

In a thirty sixth example, the method of the twenty sixth example, wherein the request to switch the UTP link from the first band to a second band comprises a link manager protocol packet.

In a thirty seventh example, the method of the twenty sixth example, wherein determining the condition of a link between the apparatus and the primary wireless audio output device on the second band is based on one or more of a Received Signal Strength Indicator (RSSI) result at the second band based on the snoop of the UTP acknowledgement at the second band.

In a thirty eighth example, the method of the thirty seventh example, wherein determining whether to switch to the second band or stay on the first band for additional transmission of audio packets is based on the RSSI result at the second band and key performance indicators (KPI) on the first band, the KPI including one or more of Retransmissions (ReTx), Non-Acknowledgements (NAK) or Transmission Flushes (TxFlush).

In a thirty ninth example, the method of the thirty eighth example, wherein switching to the second band for additional transmission of audio packets is performed when the RSSI result at the second band is higher than a first predetermined threshold or a ReTx rate, a NAK rate, or a TxFlush count is higher than a second predetermined threshold.

In a fortieth example, the method of the thirty eighth example, wherein remaining on the first band for additional transmission of audio packets is performed when the RSSI result at the second band is lower than a first predetermined threshold or a ReTx rate, a NAK rate, or a TxFlush count is lower than a second predetermined threshold.

In a forty first example, the method of the twenty sixth example, further comprising switching to the second band and generating, for transmission to the primary wireless audio output device over a second downlink on a second band, at least one audio packet.

In a forty second example, a processor configured to perform any of the methods of the twenty sixth through forty first examples.

In a forty third example, a method, comprising processing at least one audio packet received over a downlink on a first band from an audio source, generating, for transmission to the audio source over an uplink on the first band, a first acknowledgement, processing a request from the audio source to switch an UnTethered Protocol (UTP) link from the first band to a second band, generating, for transmission to the audio source over an uplink on the second band, a confirmation that a UTP switch to the second band has occurred and processing additional audio packets received from the audio source on the second band.

In a forty fourth example, the method of the forty third example, wherein the first band is an International, Scientific, and Medical (ISM) band and the second band is an Unlicensed National Information Infrastructure (UNII) band.

In a forty fifth example, the method of the forty third example, wherein the first band is an Unlicensed National Information Infrastructure (UNII) band and the second band is an International, Scientific, and Medical (ISM) band.

In a forty sixth example, the method of the forty third example, wherein the first acknowledgement is based at least in part on a second acknowledgement received from a secondary wireless audio output device.

In a forty seventh example, the method of the forty sixth example, wherein the second acknowledgement is received from the secondary wireless audio output device over an UnTethered Protocol (UTP) link on the first band.

In a forty eighth example, the method of the forty third example, further comprising determining, based on the request from the audio source to switch the UTP link to the second band, whether to switch the UTP link to the second band.

In a forty ninth example, the method of the forty eighth example, wherein determining whether to switch the UTP link to the second band is based at least in part on input from a secondary wireless audio output device.

In a fiftieth example, the method of the forty ninth example, further comprising receiving, from the secondary wireless audio output device, a second acknowledgement over the UTP link on the second band.

In a fifty first example, a processor configured to perform any of the methods of the forty third through fiftieth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising memory coupled to processing circuitry, the processing circuitry configured to:
generate, for transmission to at least one of a primary wireless audio output device and a secondary wireless audio output device over a first downlink on a first band, at least one audio packet;
process a first acknowledgement over a first uplink on the first band from the primary wireless audio output device;
determine a condition of the first downlink or the first uplink on the first band;
generate, for transmission to the primary wireless audio output device, a request to enable advertising at a second band based on the condition;
scan for an advertising packet received from the primary wireless audio output device on the second band to determine a condition of a link between the apparatus and the primary wireless audio output device on the second band; and
determine whether to switch to the second band or stay on the first band for additional transmission of audio packets based on the condition of the link on the second band.

2. The apparatus of claim 1, wherein the first acknowledgement is based at least in part on a second acknowledgement received by the primary wireless audio output device from the secondary wireless audio output device.

3. The apparatus of claim 1, wherein the processing circuity is configured to determine the condition of the first downlink or the first uplink on the first band based on key performance indicators (KPI) on the first band, the KPI including one or more of Retransmissions (ReTx), Non-Acknowledgements (NAK) or Transmission Flushes (TxFlush).

4. The apparatus of claim 3, wherein, when a ReTx rate, a NAK rate, or a TxFlush count is lower than a predetermined threshold, the processing circuitry determines that the condition of the first downlink or the first uplink on the first band is satisfactory.

5. The apparatus of claim 3, wherein, when a ReTx rate, a NAK rate, or a TxFlush count is higher than a predetermined threshold, the processing circuitry determines that the condition is unsatisfactory and a switch to the second band is to be attempted.

6. The apparatus of claim 1, wherein the processing circuitry is configured to determine the condition of a link between the apparatus and the primary wireless audio output device on the second band based on one or more of a Received Signal Strength Indicator (RSSI) result at the second band based on a result of the scan of the advertising packet.

7. The apparatus of claim 6, wherein the processing circuitry is configured to determine whether to switch to the second band or stay on the first band for additional transmission of audio packets based on the RSSI result at the second band and key performance indicators (KPI) on the first band, the KPI including one or more of Retransmissions (ReTx), Non-Acknowledgements (NAK) or Transmission Flushes (TxFlush).

8. The apparatus of claim 7, wherein the processing circuitry is configured to switch to the second band for additional transmission of audio packets when:
the RSSI result at the second band is higher than a first predetermined threshold; or
a ReTx rate, a NAK rate, or a TxFlush count is higher than a second predetermined threshold.

9. The apparatus of claim 7, wherein the processing circuitry is configured to remain on the first band for additional transmission of audio packets when:
the RSSI result at the second band is lower than a first predetermined threshold; or
a ReTx rate, a NAK rate, or a TxFlush count is lower than a second predetermined threshold.

10. An apparatus comprising memory coupled to processing circuitry, the processing circuitry configured to:
process at least one audio packet received over a downlink on a first band from an audio source;
generate, for transmission to the audio source over an uplink on the first band, a first acknowledgement;
process a request from the audio source to enable advertising on a second band;
generate, for transmission on the second band, an advertising packet; and
process additional audio packets received from the audio source on the second band.

11. The apparatus of claim 10, wherein the processing circuitry is configured to determine, based on the request from the audio source to enable advertising on the second band, whether advertising is to be enabled on the second band before the transmission of an advertising packet to the audio source on the second band.

12. The apparatus of claim 10, wherein the first acknowledgement is based at least in part on a second acknowledgement received from a secondary wireless audio output device.

13. The apparatus of claim 12, wherein the second acknowledgement is received from the secondary wireless audio output device over an UnTethered Protocol (UTP) link on the first band.

14. The apparatus of claim 12, wherein after receiving the additional audio packets from the audio source on the second band, the processing circuitry is configured to cause transmitting circuitry to transmit a third acknowledgement over an uplink to the audio source on the second band, the third acknowledgement based at least in part on a fourth acknowledgement received from the secondary wireless audio output device over an UnTethered Protocol (UTP) link on the second band.

15. An apparatus comprising memory coupled to processing circuitry, the processing circuitry configured to:
generate, for transmission to at least one of a primary wireless audio output device and a secondary wireless audio output device over a first downlink on a first band, at least one audio packet;
process a first acknowledgement over a first uplink on the first band from the primary wireless audio output device;
determine a condition of the first downlink or the first uplink on the first band;
generate, for transmission to the primary wireless audio output device, a request to switch an UnTethered Protocol (UTP) link from the first band to a second band;
receive a confirmation from the primary wireless audio output device that a UTP switch to the second band has occurred;
snoop for a UTP acknowledgement at the second band from the secondary wireless audio output device to the primary wireless audio output device; and
determine whether to switch to the second band or stay on the first band for additional transmission of audio packets based on a result of the snoop of the UTP acknowledgement at the second band.

16. The apparatus of claim 15, wherein the first acknowledgement is based at least in part on a second acknowledgement received by the primary wireless audio output device from the secondary wireless audio output device.

17. The apparatus of claim 15, wherein the processing circuity is configured to determine the condition of the first downlink or the first uplink on the first band based on key performance indicators (KPI) on the first band, the KPI including one or more of Retransmissions (ReTx), Non-Acknowledgements (NAK) or Transmission Flushes (TxFlush).

18. The apparatus of claim 17, wherein, when a ReTx rate, a NAK rate, or a TxFlush count is lower than a predetermined threshold, the processing circuitry determines that the condition of the first downlink or the first uplink on the first band is satisfactory.

19. The apparatus of claim 17, wherein, when a ReTx rate, a NAK rate, or a TxFlush count is higher than a predetermined threshold, the processing circuitry determines that the condition is unsatisfactory and the UTP switch to the second band is to be attempted.

20. The apparatus of claim 15, wherein the processing circuitry is configured to determine the condition of the first downlink or the first uplink between the apparatus and the primary wireless audio output device on the second band based on one or more of a Received Signal Strength Indicator (RSSI) result at the second band based on the snoop of the UTP acknowledgement at the second band.
